(19) United States
(12) Patent Application Publication
(10) Pub. No.: US 2022/0379607 A1
(43) Pub. Date: Dec. 1, 2022

(54) PRINTHEAD WITH OFFSET CIRCULATION CHANNEL

(71) Applicant: Hewlett-Packard Development Company, L.P., Spring, TX (US)

(72) Inventors: Jacob Lum, Corvallis, OR (US); James A. Feinn, San Diego, CA (US); Mengqian Lu, San Diego, CA (US); Garrett E. Clark, Corvallis, OR (US)

(73) Assignee: Hewlett-Packard Development Company, L.P., Spring, TX (US)

(21) Appl. No.: 17/775,934

(22) PCT Filed: Dec. 10, 2019
(86) PCT No.: PCT/US2019/065535

§ 371 Date: May 11, 2022

(51) Int. Cl. B41J 2/14

(52) U.S. Cl. CPC B41J 2/14145; B41J 2/1404; B41J 2202/11; B41J 2202/12

(57) ABSTRACT

An example printhead includes a set of circulation channels for flowing a fluid therethrough, the set of nozzles including higher-pressure channels and lower-pressure channels; a first nozzle array having a first nozzle; a second nozzle array having a second nozzle, the first nozzle and the second nozzle forming a row region; a first inter-channel passage fluidically coupling the first nozzle to a first pair of adjacent circulation channels, the first pair including a higher-pressure channel on a first side of a lower-pressure channel; and a second inter-channel passage fluidically coupling the second nozzle to a second pair of adjacent circulation channels, the second pair including a higher-pressure channel on a second side of a lower-pressure channel, the second side being opposite the first side.

### BACKGROUND

Printers are commonplace in both home environments and office environments. Such printers can include laser printers, inkjet printers or other types of printers. Generally, inkjet printers include printheads which deposit marking fluids, such as ink, onto a print medium, such as paper. The printheads may move across the width of the print medium to selectively deposit marking fluids to produce the desired image. In other examples, printheads may remain stationary and the print medium may be moved with respect to the printheads while marking fluids are deposited. Marking fluid droplets may be propelled from the printheads onto paper or other materials to form text, images, and objects. The droplets are ejected from nozzles in the printhead as the printhead traverses a print carriage while the paper is advanced.

The marking fluid is generally flowed from a fluid reservoir to the nozzles through recirculation channels via a pump. In some examples, the pump generates a pressure differential which directs the fluid through the circulation channels, past the nozzles, and back to the reservoir. Some of the fluid is ejected via the nozzles by selectively operating actuators associated with the nozzles. The fluid ejected via the nozzles is deposited onto the print medium.

### BRIEF DESCRIPTION OF THE DRAWINGS

For a more complete understanding of various examples, reference is now made to the following description taken in connection with the accompanying drawings in which:

FIG. 1 illustrates a top view of an example printhead;

FIG. 2 illustrates a cross-sectional side view of an example fluidic die with a fluidic coupling of a nozzle;

FIG. 3 illustrates an example apparatus with an example printhead;

FIG. 4 illustrates a top view of another example printhead; and

FIG. 5 illustrates a top view of another example printhead.

### DETAILED DESCRIPTION

As noted above, droplets are ejected via printhead nozzles onto a print medium. Various nozzles in the printhead can be arranged to form a row region, In some arrangements, differences in print quality from one row region to another can result in drop shape and trajectory defects, such as striping. Such differences can occur from differing conditions in one row compared to an adjacent row, such as differing thermal and pressure characteristics resulting from flow in a common circulation channel for nozzles in a particular row region. For example, a row region coupled to a first circulation channel may have different characteristics than another row region coupled to a second circulation channel. Thus, differences in the flow under the nozzle and thermal and pressure characteristics in two channels can result in different print quality in the associated the row regions.

Various examples described herein relate to printheads that can provide improved print quality. In various examples, different nozzles in a particular row region are coupled to flow from different circulation channels. Thus, with each row region having nozzles receiving flow from different circulation channels, defects such as striping caused by thermal or pressure characteristics of a single circulation channel are mitigated. In some examples, the nozzles in a particular row region are coupled to two adjacent circulation channels via an inter-channel passage. In this regard, at least some nozzles in a row region are coupled to a first pair of adjacent circulation channels and other nozzles in the row region are coupled to a second pair of adjacent circulation channels.

An example printhead is provided with two sets of nozzle arrays. A set of circulation channels flows fluid to the nozzle arrays. The two nozzle arrays includes sets of nozzles, wherein a nozzle in the first array has a corresponding nozzle in the second array, defining a row region. Each nozzle in the nozzle arrays is fluidically coupled to two adjacent circulation channels through a fluidic coupling. The fluidic coupling includes an inter-channel passage coupling the nozzle to each of the adjacent circulation channels. The circulation channels are offset such that the two nozzles in a row region have fluid flowing through the respective inter-channel passages in different directions. In some cases, the different directions are opposite to each other. The offset may be formed by providing the circulation channels with a diagonal portion between the nozzle arrays. In other examples the offset may be formed via chevrons within each nozzle array. Offsetting the circulation channels allows flow within the nozzles arrays (e.g., through inter-channel passages) to be in different directions at the two corresponding nozzles of a row region.

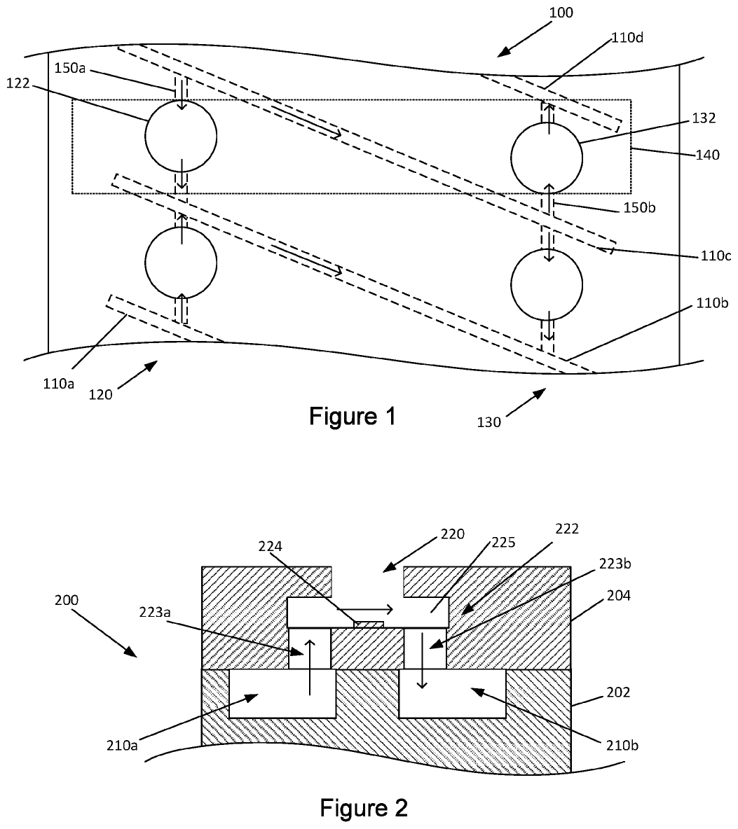

Referring now to FIG. 1, a top view of an example printhead is illustrated. The example printhead 100 may be formed of any of a variety of materials. In one example, the printhead 100 is formed as a fluidic die with layers of materials such as silicon. The example printhead 100 of FIG. 1 is formed with a set of circulation channels 110a-d through which fluid, such as a printing fluid, can be flowed. The circulation channels 110a-d extend substantially across the length of the printhead 100. For example, in FIG. 1, the circulation channels 110a-d extend substantially from the left side of the printhead 100 across the length of the printhead 100 to the right side of the printhead 100.

Each circulation channel 110a-d can be coupled to a fluid reservoir (not shown in FIG. 1) from which the fluid is directed into the circulation channels 110a-d. In some examples, the circulation channels 110a-d are recirculation channels through which the fluid can be redirected to the fluid reservoir. In this regard, the example printhead 100 of FIG. 1 may include a pump to facilitate flow of the fluid.

The example printhead 100 of FIG. 1 includes a first nozzle array 120 including a set of nozzles, such as a first nozzle 122. The example printhead further includes a second nozzle array 130 including a set of nozzles, such as a second nozzle 132. Each nozzle in the nozzle arrays 120, 130 is fluidically coupled to the circulation channels 110a-d. Thus, as fluid flows through the circulation channel 110a-d, the fluid may be ejected via the nozzles 122, 132 onto, for example, a print medium.

As illustrated in FIG. 1, the nozzles 122, 132 are fluidically coupled to the circulation channels 110a-d through a set of inter-channel passages, such as inter-channel passages 150a, 150b. In this regard, each inter-channel passage 150a, 150b fluidically couples a nozzle 122, 132 to two adjacent circulation channels 110a-d. For example, in FIG. 1, the nozzle 122 of the first nozzle array 120 is coupled via the inter-channel passage 150a to adjacent circulation channels 110b and 110c. Similarly, the nozzle 132 of the second nozzle array 130 is coupled via the inter-channel passage 150b to adjacent circulation channels 110c and 110d.

The circulation channels 110a-d include some channels that are coupled to the high-pressure side of a pump which provides fluid from a fluid reservoir to the circulation channels. For example, circulation channels 110a and 110c may be coupled to inlets which receive fluid directed to the circulation channels 110a, 110c from a fluid reservoir by a pump. In this regard, these circulation channels 110a, 110c are referred to herein as “higher-pressure channels.” Conversely, other channels of the circulation channels 110a-d are coupled to the low-pressure side of the pump. For example, circulation channels 110b and 110d may be coupled to outlets which direct fluid from the circulation channels 110b, 110d to the reservoir. In this regard, these circulation channels 110b, 110d are referred to herein as “lower-pressure channels.” Thus, each pair of adjacent circulation channels coupled to a nozzle 122, 132 includes a higher-pressure channel and a lower-pressure channel.

The nozzles 122, 132 in the nozzle arrays 120, 130 form row regions 140. In this regard, the nozzles are substantially aligned in the length-wise direction and overlap a region which may correspond to a pixel, a row of pixels or a part thereof. Thus, during printing, the nozzles in the row region 140 deposit print fluid on a common region or pixel.

As described above, differences in print quality from one row region to another can result in defects, such as striping. The example printhead 100 of FIG. 1 mitigates or eliminates such defects by mixing the direction of fluid flow through the inter-channel passages 150a, 150b of the nozzles 122, 132 in a row region 140. As illustrated in FIG. 1, the flow of fluid through the inter-channel passage 150a of the first nozzle 122 is downward, as indicated by the arrow, while the flow of fluid through the inter-channel passage 150b of the second nozzle 132 is upward. The mixing of the flow direction through the inter-channel passages 150a, 150b of nozzles in a row region 140 is achieved by providing an offset in the circulation channels 110a-d. For example, the pair of circulation channels 110b, 110c fluidically coupled to the first nozzle 122 is different from the pair of circulation channels 110c, 110d fluidically coupled to the second nozzle 132 of the row region 140.

In the example printhead 100 of FIG. 1, fluid flows through the circulation channel from a fluid reservoir (not shown in FIG. 1). In one example, a pump may direct the fluid from the fluid reservoir to at least some of the circulation channels (e.g., the higher-pressure channels 110a, 110c), through the inter-channel passages 150a, 150b, and to at least some other circulation channels (e.g,, the lower-pressure channels 110b, 110d), from which the fluid is returned to the fluid reservoir. Thus, in the example of FIG. 1, the fluid from the fluid reservoir is directed into the higher-pressure channels 110a and 110c. In the first nozzle array 120, a pressure differential generated by the pump causes at least some of the fluid to flow from the higher-pressure channels 110a and 110c, through the inter-channel passages and into the lower-pressure channels 110b. Other fluid may continue to flow through the higher-pressure channels 110a and 110c. In the second nozzle array 130, the pressure differential generated by the pump causes at least some of the fluid to flow from the higher-pressure channel 110c, through the inter-channel passages and into the lower-pressure channels 110b and 110d. Thus, the fluid flows through the inter-channel passages 150a, 150b from a circulation channel with higher pressure to a circulation channel with a lower pressure.

At the first nozzle 122 of the first nozzle array 120, the higher-pressure channel 110c is on a first side (upper side in FIG. 1) of the lower-pressure channel 110b. Thus, fluid flows through the inter-channel passage 150a from the higher-pressure channel 110c to the lower-pressure channel 110b in a downward direction. At the second nozzle 132 of the second nozzle array 130, the higher-pressure channel 110c is on a second side (lower side in FIG. 1) of the lower-pressure channel 110d. Thus, fluid flows through the inter-channel passage 150b from the higher-pressure channel 110c to the lower-pressure channel 110d in an upward direction.

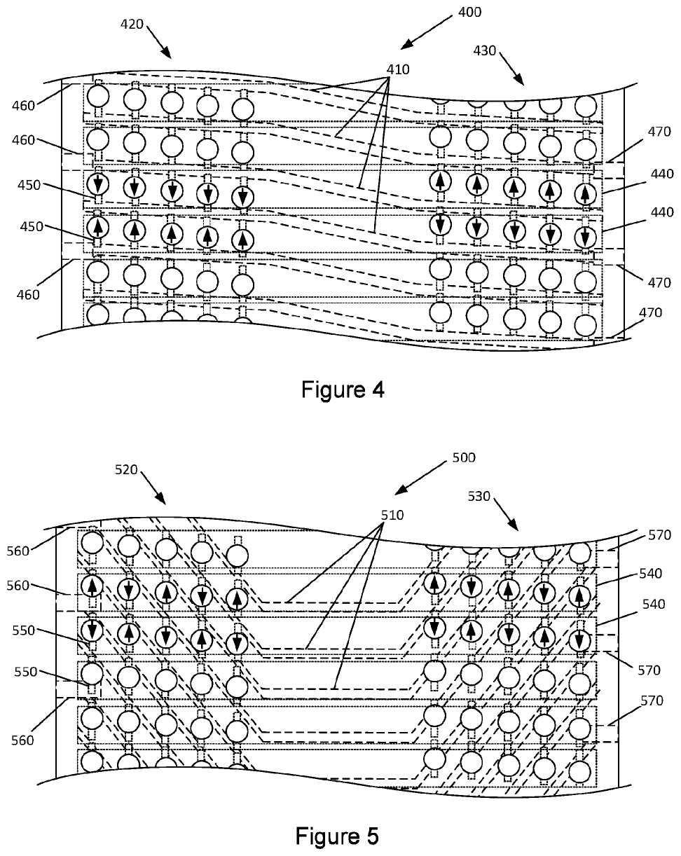

In the example printhead 100 of FIG. 1, an offset of the circulation channels 110a-d is provided by forming the circulation channels 110a-d in a diagonal arrangement. The offset allows positioning of the higher-pressure channel and the lower-pressure channel in different arrangements at the first nozzle 122 and the second nozzle 132. Various other configurations of the circulation channels 110a-d may be provided to form the offset, some examples of which are described below with reference to FIGS. 4 and 5.

FIG. 2 illustrates a cross-sectional side view of an example fluidic die 200 with a nozzle 220. The example fluidic die 200 of FIG. 2 is formed with a fluidic channel layer 202 and a nozzle layer 204. The fluidic channel layer 202 includes a number of fluid channels 210a, 210b, similar to the circulation channels 110a-d described above with reference to FIG. 1. In this regard, the fluid channels 210a, 210b extend across a length of the fluidic die (into and out of the page in the illustration of FIG. 2).

The nozzle layer 204 includes nozzles, such as nozzle 220, to eject fluid therethrough. As described above with reference to FIG. 1, the nozzle 220 may be positioned with other nozzles on the nozzle layer 204 to form row regions. The nozzle 220 is coupled to the two adjacent fluid channels 210a, 210b through a fluidic coupling 222. The fluidic coupling 222 includes feed holes 223a, 223b and an inter-channel passage 225.

The nozzle 220 is further provided with a corresponding actuator 224 to selectively eject the fluid through the nozzle 220. In various examples, the actuator 224 may be a thermal ink jet (TIJ) resistor, a piezoelectric element or any of a variety of other types of actuators.

The example fluidic coupling 222 illustrated in FIG. 2 couples the nozzle 220 to the adjacent fluid channels 210a, 210b. Flow in the adjacent channels 210a, 210b may be in a parallel direction, as illustrated in the example printhead 100 of FIG. 1, or in opposite directions.

Thus, in the example of FIG. 2, fluid is directed from the first fluid channel 210a through the first feed hole 223a, as indicated by the upward arrow in FIG. 2. As described above with reference to FIG. 1, fluid flows from a fluid channel 210a with a higher pressure toward another fluid channel 210b with a lower pressure, where the pressure differential may result from operation of a pump, for example. The first feed hole 223a is in fluid communication with inter-channel passage 225 through which the fluid is flowed past the actuator 224. Selective operation of the actuator 224 causes fluid to be ejected from the nozzle 220. Fluid that is not ejected is directed through the inter-channel passage 225 to the second feed hole 223b and into the second fluid channel 210b.

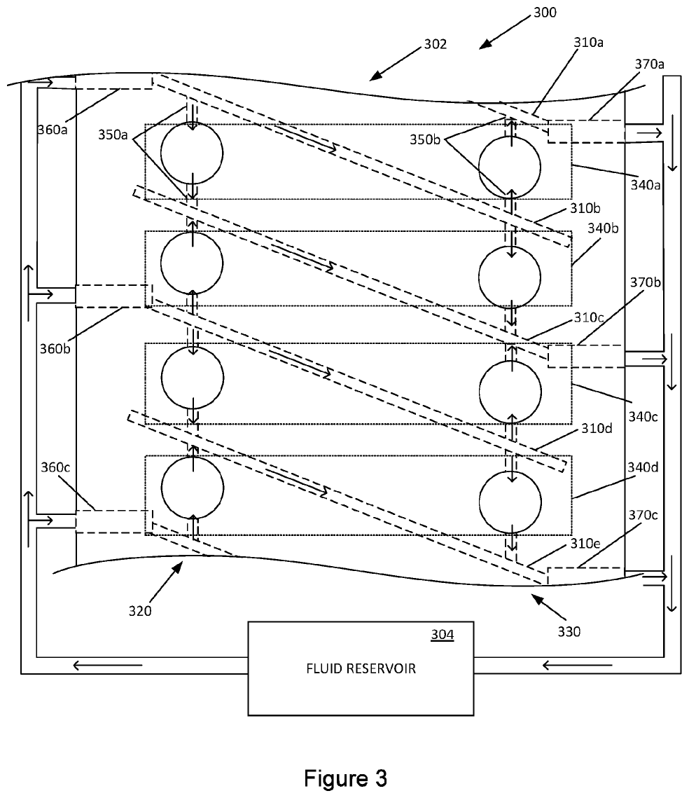

Referring now to FIG. 3, an example apparatus with an example printhead is illustrated. The example apparatus 300 includes a printhead 302 and a fluid reservoir 304. The fluid reservoir 304 may be a replaceable or refillable fluid tank and is fluidically coupled to the printhead 302. The printhead 302 is provided with a set of circulation channels 310a-e which are coupled to the fluid reservoir 304. The circulation channels 310a-e extend substantially from a first end (e.g., the left end of the printhead 302) to the second end (e.g., the right end of the printhead 302). The printhead 302 may be similar to the printheads described above with reference to FIGS. 1 and 2. In this regard, in addition to the circulation channels 310a-e, the printhead 302 includes a first nozzle array 320 and a second nozzle array 330. Each nozzle array 320, 330 is provided with a set of nozzles forming row regions 340a-d. Further, as described above, each nozzle is fluidically coupled to a pair of adjacent circulation channels 310 via inter-channel passages, such as inter-channel passages 350a, 350b.

The printhead 302 is fluidically coupled to the fluid reservoir 304 through inlets 360a-c and outlets 370a-c. Each inlet 360a-c is coupled to some of the circulation channels, such as circulation channels 310b, 310d, while each outlet 370a-c is coupled to some of the circulation channels, such as circulation channels 310a, 310c, 310e. The inlets 360a-c are formed proximate a first end of the printhead 302 (e.g., the left end in FIG. 3), and the outlets 370a-c are formed proximate a second end of the printhead 302 (e.g., the right end in FIG. 3).

Thus, in the example of FIG. 3, fluid is received into some circulation channels, such as circulation channels 310b, 310d through inlets 360a, 360b. A pump (not shown in FIG. 3) may be provided to cause the fluid to flow from the fluid reservoir 304 to the inlets 360a, 360b. The fluid then flows across the inter-channel passages 350a as indicated by the arrows in FIG. 3. The fluid may then be ejected through a nozzle in the nozzle arrays 320 or flowed to the adjacent circulation channel, such as circulation channel 310c, and then directed to an outlet, such as outlet 370b that is fluidically coupled to the circulation channel 310c. Of course, other components, such as pumps, and pressure regulators, may be provided to facilitate fluid flow from the fluid reservoir through the circulation channels 310a-e.

As described above with reference to FIG. 1, the circulation channels 310a-e have an offset in a width-wise direction (top-bottom in FIG. 3) as each circulation channel extends substantially in a length-wise direction (from left to right in FIG. 3). In the example of FIG. 3, the offset is provided by forming the circulation channels 310a-e in a diagonal configuration. In this regard, the nozzles in a row region are fluidically coupled to different pairs of adjacent circulation channels 310a-e. For example, in the top row region 340a, the nozzle in the first nozzle array 320 is coupled to adjacent circulation channels 310b, 310c, while the nozzle in the second nozzle array 330 is coupled to adjacent circulation channels 310a, 310b. This offset results in fluid flow in the inter-channel passages 350a, 350b associated with nozzles in a row region 340a in different directions. In the example printhead 300 of FIG. 3, the different directions are opposite from one another. For example, the fluid flow through the inter-channel passage 350a is in the downward direction, while the fluid flow through the inter-channel passage 350b is in the upward direction. In various examples, the nozzles in a row region are substantially aligned in the lengthwise direction. In this regard, the alignment may be sufficient to provide at least some overlap within the row region. For example, at least some overlap is provided between the coverage (top to bottom) of a nozzle in the first nozzle array 320 and the corresponding nozzle in the second nozzle array 330.

In the example printhead 302 of FIG. 3, the direction of flow of fluid through the inter-channel passages 350a, 350b results from the fluid pressure differential in the fluidic channels of the printhead 302. The fluid pressure differential may be provided by, for example, a pump which circulates the fluid from the fluid reservoir 304 into the printhead 302. In particular, the pump causes a pressure differential between the inlets 360a-c and the outlets 370a-c. The fluid pressure differential results in the fluid being flowed from the fluid reservoir 304 into the inlets 360a-c, through the circulation channels 310a-e, the inter-channel passages 350a, 350b and through the outlets 370a-c.

As noted above, each nozzle in the nozzle arrays 320, 330 is coupled to a pair of adjacent circulation channels 310a-e. As illustrated in the example of FIG. 3, the circulation channels 310a-e are alternatingly coupled to either an inlet 360a-c or an outlet 370a-c. For example, inlets 360a, 360b are coupled to circulation channels 310b, 310d, while outlets 370a-c are coupled to circulation channels 310a, 310c, 310e. Thus, of the pair of adjacent circulation channels 310a-e coupled to each nozzle of the nozzle arrays 320, 330, one circulation channel is coupled to an inlet, while the other circulation channel of the pair is coupled to an outlet. Due to the fluid pressure differential, fluid flowing through the inter-channel passages 350a, 350b flows from the circulation channel coupled to an inlet 360a-c (higher pressure side) to the circulation channel coupled to an outlet 370a-c (lower pressure side).

Referring now to FIG. 4, a top view of another example printhead is illustrated. The example printhead 400 of FIG. 4 is similar to the example printhead 100 described above with reference to FIG. 1 and includes a set of circulation channels 410 and a set of nozzles 420, 430. The nozzles 420, 430 are shown separated into a first array 420 and a second array 430 with the nozzles arranged in row regions 440. As noted above, the row regions include nozzles with overlapping coverage in the length-wise direction. In the example of FIG. 4, each row region 440 includes a number of nozzles in each of the first array of nozzles 420 and the second array of nozzles 430. Each nozzle of the arrays 420, 430 is fluidically coupled to an inter-channel passage 450 coupling the nozzles to a pair of adjacent circulation channels 410.

The circulation channels 410 are alternatingly coupled to an inlet 460 or an outlet 470. As noted above, of the pair of adjacent circulation channels 410 coupled to a nozzle, one circulation channel 410 is coupled to an inlet 460, while the other is coupled to an outlet 470. Thus, fluid flows through an inter-channel passage 450 from the circulation channel 410 coupled to an inlet 460 to the circulation channel 410 coupled to an outlet 470. The direction of flow through the nozzles of two row regions 440 is illustrated in FIG. 4 with arrows. As illustrated in FIG. 4, each row region includes a first portion of nozzles with upward flow in the inter-channel passages 450 and a second portion nozzles with downward flow in the inter-channel passages. In the example of FIG. 4, the first portion of nozzles is in the first array of nozzles 420 and the second portion of nozzles is in the second array of nozzles 430 on the opposite side of the printhead 400.

As noted above, an offset in the circulation channels 410 results in a mixing of the direction of flow through the inter-channel passages 450 in a row region 440. In various examples, the offset of the circulation channels 410 is provided by forming at least a portion of the circulation channels 410 in a diagonal arrangement. In the example printhead 400 of FIG. 4, the offset is formed by providing a diagonal arrangement between the first nozzle array 420 and the second nozzle array 430.

Referring now to FIG. 5, a top view of another example printhead is illustrated. The example printhead 500 of FIG. 5 is similar to the example printhead 400 described above with reference to FIG. 4 and includes a set of circulation channels 510, a first array of nozzles 520, and a second array of nozzles 530 with the nozzles arranged in row regions 540. Each nozzle of the arrays 520, 530 is fluidically coupled to an inter-channel passage 550 coupling the nozzles to a pair of adjacent circulation channels 510.

Similar to the example printhead 400 of FIG. 4, the circulation channels 510 are alternatingly coupled to an inlet 560 or an outlet 570. As noted above, of the pair of adjacent circulation channels 510 coupled to a nozzle, one circulation channel 510 is coupled to an inlet 560, while the other is coupled to an outlet 570. Thus, fluid flows through an inter-channel passage 550 from the circulation channel 510 coupled to an inlet 560 to the circulation channel 510 coupled to an outlet 570. The direction of flow through the nozzles of two row regions 540 is illustrated in FIG. 5 with arrows. As noted above, each row region includes a first portion of nozzles with upward flow in the inter-channel passages 550 and a second portion nozzles with downward flow in the inter-channel passages 550. In the example of FIG. 5, the first portion of nozzles and the second portion of nozzles are spread out, or distributed, across the first array of nozzles 420 and the second array of nozzles 430.

As noted above, an offset in the circulation channels 510 results in a mixing of the direction of flow through the inter-channel passages 550 in a row region 540. In the example printhead 500 of FIG. 5, the offset is formed by providing a diagonal arrangement within each of first nozzle array 520 and the second nozzle array 530.

FIGS. 4 and 5 illustrate two example arrangements of the circulation channels 410, 510 to provide an offset. Various other arrangements for providing the offset are possible and are contemplated within the scope of the present disclosure. Further, in the examples of FIGS. 4 and 5, the number of nozzles with fluid flowing through the inter-channel passages in each direction is substantially equal. In other examples, the number of nozzles with flow in the two directions may be substantially different. For example, the number of nozzles in a row region with fluid through the inter-channel passage in one direction may be between about 20 percent and about 80 percent, between about 30 and about 70 percent, or between about 40 and about 60 percent.

It is noted that the foregoing description uses terms like “and/or,” “at least,” “one or more,” and other like open-ended terms in an abundance of caution. However, this is done without limitation. And unless expressly stated otherwise, singular terms (e.g., “a,” “an,” or “one” component) are not intended to restrict to only the singular case but are intended to encompass plural cases as well. Similarly, “or” is intended to be open-ended, unless stated otherwise, such that “A or B” may refer to A only, B only, and A and B.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A printhead, comprising:
a set of circulation channels for flowing a fluid therethrough, the set of nozzles including higher-pressure channels and lower-pressure channels;
a first nozzle array having a first nozzle;
a second nozzle array having a second nozzle, the first nozzle and the second nozzle forming a row region;
a first inter-channel passage fluidically coupling the first nozzle to a first pair of adjacent circulation channels, the first pair including a higher-pressure channel on a first side of a lower-pressure channel; and
a second inter-channel passage fluidically coupling the second nozzle to a second pair of adjacent circulation channels, the second pair including a higher-pressure channel on a second side of a lower-pressure channel, the second side being opposite the first side.

2. The printhead of claim 1, wherein the first pair of adjacent circulation channels is different from the second pair of adjacent circulation channels.

3. The printhead of claim 1, wherein the set of circulation channels includes an offset to cause fluid to flow through the first inter-channel passage between the first pair of adjacent circulation channels in a first direction and fluid to flow through the second inter-channel passage between the second pair of adjacent circulation channels in a second direction, the second direction being different from the first direction.

4. The printhead of claim 2, wherein the offset of the circulation channels is provided within one of the first nozzle array or the second nozzle array.

5. The printhead of claim 2, wherein the offset of the circulation channels is provided in a portion of the circulation channels between the first nozzle array and the second nozzle array.

6. The printhead of claim 1, further comprising:
an inlet proximate to a first end of the set of circulation channels, the inlet fluidically coupling a higher-pressure channel to a fluid reservoir; and
an outlet proximate to a second end of the set of circulation channels, the outlet fluidically coupling a lower-pressure channel to the fluid reservoir, the second end being opposite the first end.

7. The printhead of claim 1, wherein the first nozzle in the first nozzle array and the second nozzle in the second nozzle array include an actuator to selectively eject fluid from the nozzle.

8. The printhead of claim 1, wherein the first inter-channel passage is coupled to a first circulation channel via a first feed hole and to a second circulation channel via a second feed hole.

9. A fluidic die, comprising:
a fluidic channel layer defining a number of fluid channels therein, the fluid channels extending across a length of the fluidic die;
a nozzle layer including nozzles to eject fluid therethrough, the nozzles being positioned to form row regions, wherein each nozzle includes an inter-channel passage fluidically coupling the nozzle with two adjacent fluid channels;
wherein the fluid channels have an offset in a width-wise direction as each fluid channel traverses the length of the fluidic die from an inlet to an outlet, the offset to cause fluid to flow in a first direction through the inter-channel passage of a first portion of nozzles in a row region and in a second direction through the inter-channel passage of a second portion of nozzles in the row region, the second direction being different from the first direction.

10. The fluidic die of claim 9, further comprising:
the inlet fluidically coupled to a fluid channel proximate to a first end of the length of the fluidic die; and
the outlet fluidically coupled to a fluid channel proximate to a second end of the length of the fluidic die, the second end being opposite the first end.

11. The fluidic die of claim 9, wherein the offset of the fluid channels is provided by a diagonal arrangement of at least a portion of the fluid channels.

12. The fluidic die of claim 9, wherein a number of nozzles in the first portion and a number of nozzles in the second portion is substantially equal.

13. The fluidic die of claim 9, wherein the first portion of nozzles and the second portion of nozzles are on opposite sides of the nozzle layer.

14. The fluidic die of claim 9, wherein the first portion of nozzles and the second portion of nozzles are each spread out through the row region.

15. An apparatus, comprising:
a fluid reservoir; and
a printhead, the printhead comprising:
an inlet formed proximate a first end of the printhead, the inlet being fluidically coupled to the fluid reservoir;
an outlet formed proximate a second end of the printhead, the outlet being fluidically coupled to the fluid reservoir;
a set of circulation channels extending substantially from the first end to the second end, at least one circulation channel being fluidically coupled to the inlet proximate the first end and at least one circulation channel being fluidically coupled to the outlet proximate the second end;
a set of nozzles forming row regions to eject fluid therefrom; and
a set of inter-channel passages, each inter-channel passage fluidically coupling a nozzle to two adjacent circulation channels,
wherein the fluid channels have an offset in a width-wise direction as each fluid channel extend substantially from the first end to the second end, the offset to cause fluid to flow in a first direction through the inter-channel passage of a first portion of nozzles in a row region and in a second direction through the inter-channel passage of a second portion of nozzles in the row region, the second direction being different from the first direction.
